(19) United States
(12) Patent Application Publication
(10) Pub. No.: US 2023/0358192 A1
(43) Pub. Date: Nov. 9, 2023

(54) SYSTEM AND METHOD TO REDUCE DUST INGESTION INTO FUEL EVAPORATION SYSTEM

(71) Applicant: FORD GLOBAL TECHNOLOGIES, LLC, Dearborn, MI (US)

(72) Inventor: Aed DUDAR, Canton, MI (US)

(21) Appl. No.: 17/736,203

(22) Filed: May 4, 2022

(51) Int. Cl. F02M 25/08; B60K 15/04; F02M 35/10; F02D 41/00

(52) U.S. Cl. CPC F02M 25/0818; B60K 15/04; F02D 41/003; F02M 25/0836; F02M 35/10222; G01N 2015/0693

(57) ABSTRACT

A fuel vapor recovery system is disclosed that includes a fuel tank and a filler neck that port fuel vapor to a vapor storage canister. Data is received from onboard or external sources that indicate a quantity of dust particles in the environment of the vehicle. A controller responsive to the data indicating the quantity of dust controls a valve to provide purge air received through a dust box to the vapor storage canister when the quantity of dust particles is below a predetermined threshold. The valve is switched to provide purge air from an engine intake system to the vapor storage canister when the quantity of dust particles is above the predetermined threshold.

### TECHNICAL FIELD

This disclosure relates to methods and systems for controlling dust ingestion into a vehicle fuel vapor storage canister.

### BACKGROUND

Vehicle fuel systems include evaporative emission control systems designed to reduce the release of fuel vapors to the atmosphere. For example, vaporized hydrocarbons (HCs) from a fuel tank may be stored in a fuel vapor canister packed with an adsorbent which adsorbs and stores the vapors. When the engine is in operation, the evaporative emission control system allows the vapors to be purged into the engine intake manifold for use as fuel.

The engine when running generates manifold vacuum. When a canister purge valve is opened air is drawn into the fuel vapor canister by the vacuum to remove fuel vapor that was previously adsorbed by an adsorbent contained in the canister.

Vehicles may be operated in dusty environments such as unpaved roads and when off-road driving. Fuel vapor canisters are supplied with air through a dust box having filters that remove dust from the air when air is drawn into the canister when purging. If the dust box filters are clogged by a large amount of dust, the flow of air to the canister may become restricted and the canister may be unable to purge efficiently. A clogged dust box may cause premature shut offs during refilling.

Fine dust particles may pass through the filters in the dust box and may cover carbon pellets inside the canister that may affect evaporative emission adsorption and desorption working capacity.

This disclosure is directed to solving the above problems and other problems as summarized below.

### SUMMARY

According to one aspect of this disclosure, a system is disclosed for providing purge air from an engine intake system to a vapor storage canister when the quantity of dust particles in the vicinity of a vehicle is above a predetermined threshold. The system includes a fuel tank having at least one grade limit venting valve, and a fuel limit venting valve. A fuel filler conduit that the grade limit venting valve and the fuel limit venting valve that open into and a filler neck for supplying fuel to the fuel tank. A fuel tank pressure sensor monitors a pressure in the fuel filler conduit. A vapor storage canister of an evaporative emission system includes a buffer and the fuel filler conduit transfers fuel vapor through the buffer to the vapor storage conduit. The vapor storage conduit encloses a fuel vapor storage medium that stores the fuel vapor until the canister is purged. An air vent supplies purge air to the vapor storage canister through a first air supply conduit and purge air is selectively drawn into the air vent through a dust box under normal driving conditions. An intake manifold is adapted to supply air to the vehicle engine. Purge air is selectively drawn into the vapor storage canister through a second air supply conduit through the intake manifold air filter. A valve is provided in the first air supply conduit and the second air supply conduit. A source of data is referenced that indicates the quantity of dust particles in the environment where a vehicle is operated. A controller passes the stored fuel vapor into the intake manifold when the engine is operating and when the canister is purged. The controller is responsive to the data indicating the quantity of dust to control providing purge air from the first air supply conduit through the dust box to the vapor storage canister when the quantity of dust particles is below a predetermined threshold, and provides purge air from the second air supply conduit from the engine intake system to the vapor storage canister when the quantity of dust particles is above the predetermined threshold.

According to other aspects of this disclosure relating to the above aspect of the disclosure, the valve may be a three-way valve with a first port that is opened to provide purge air from the first air supply conduit, a second port that is opened to provide purge air from the second air supply conduit, and a third port that prevents purge air from being provided to the vapor storage canister in a leak test mode.

The source of data may be an on-board sensor, or the source of data may be data from a source external to the vehicle that provides data via a modem on the vehicle relating to the extent of dust in the environment of the vehicle.

According to another aspect of this disclosure, a system is disclosed that includes a fuel tank having a filler neck for supplying fuel to the fuel tank. A vapor storage canister of an evaporative emission system stores fuel vapor received from the filler neck and fuel tank. A source of data received from onboard or external sources that indicate a quantity of dust particles in the environment of the vehicle and a controller responsive to the data indicating the quantity of dust. A valve responsive to the controller provides purge air from a first source of purge air through a dust box to the vapor storage canister when the quantity of dust particles is below a predetermined threshold. The valve provides purge air from a second source of purge air from an engine intake system to the vapor storage canister when the quantity of dust particles is above the predetermined threshold.

According to alternative aspects of the above the system, the source of data may be an on-board sensor, such as a camera, or may be a laser, an infrared sensor, or an optical sensor.

Alternatively, the source of data is data may be obtained from a global positioning map indicating that the vehicle is not being operated on a paved road or may be obtained from a source external to the vehicle that provides data via a modem on the vehicle relating to the extent of dust in the environment of the vehicle.

The controller may select the source of purge air by switching a valve to provide purge air from the first source or the second source. The valve may be a three-way valve with a first port that is opened to provide purge air from the first source, a second port that is opened to provide purge air from the second source, and a third port that prevents purge air from being provided to the vapor storage canister in a leak test mode.

This disclosure also comprehends a method for controlling a source of purge air supplied to a vapor storage canister of an evaporative emission system. Based upon a sensed volume, or density, of dust particles in an environment of a vehicle, purge air for the vapor storage cannister may be switched from a first source of purge air through a dust box or from a second source of purge air obtained from an engine intake system.

The above aspects of this disclosure and other aspects will be described below with reference to the attached drawings.

### BRIEF DESCRIPTION OF THE DRAWINGS

FIG. 1 is a partial perspective view of a vehicle including an engine and fuel tank equipped with an evaporative emission system equipped with a system for reducing dust ingestion according to one embodiment of this disclosure.

FIG. 2 is a diagram of the system for reducing dust ingestion under normal operation when excessive dust is not present in the environment of the vehicle.

FIG. 3 is a diagram of the system for reducing dust ingestion when excessive dust is present in the environment of the vehicle.

FIG. 4 is a diagram of the system for reducing dust ingestion in a sealed leak detection position.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Various features illustrated and described with reference to any one of the figures may be combined with features illustrated in one or more of the other figures to produce embodiments that are not explicitly illustrated or described. The combinations of features illustrated provide representative embodiments for typical applications. Various combinations and modifications of the features consistent with the teachings of this disclosure could be used in particular applications or implementations.

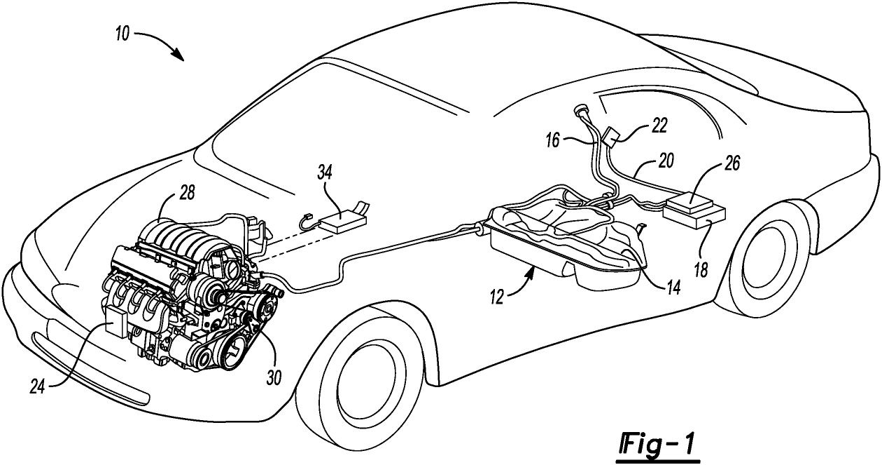

Referring to FIG. 1, a vehicle 10 is shown that includes a fuel system generally indicated by reference numeral 12. While the illustrated vehicle is an internal combustion vehicle this disclosure is also applicable to diesel and hybrid types of vehicles. The fuel system includes a fuel tank 14 that is filled through a fuel filler conduit 16. A fuel vapor storage cannister 18 receives fuel vapors created when fuel is pumped into the fuel filler conduit 16 and the vapors are stored in a adsorbent material, such as activated carbon, or the like. A first purge air line 20 is provided to capture dust in the environment of the vehicle 10 under normal driving conditions. The dust box 22 has a finite capacity and can become filled and may require replacement if the vehicle is operated in extremely dusty conditions.

A front dust sensor 24 and/or a rear dust sensor 26 may be provided onboard the vehicle 10. The front dust sensor 24 may be preferred as it will be able to detect dusty conditions around a moving vehicle at an earlier time as it enters the dusty area. The rear dust sensor may be preferred if it is already provided on the vehicle, for example it may be a pre-existing back up camera.

In dusty conditions when the volume or density of dust in the environment of the vehicle 10 is greater than a predetermined level, such as when driving off-road, or on an unpaved road, it may be preferred to bypass the dust box 22 and provide purge air through a second purge air line that takes air from the intake manifold 28 of the engine 30. The intake manifold 28 receives air through the engine air filter that is easily changed if it becomes filled with dust.

A controller 34 is provided that receives data indicating the level of dust in the environment of the vehicle 10 from onboard sources such as the front dust sensor 24, rear dust sensor 26, a dust sensor in a different location. Alternatively, a modem that may be part of the controller 34 may be used to receive data from an external source, such as a global positioning system (GPS) map indicating an unpaved road or off-road location, or from reports of weather conditions that may be received from a broadcast, the internet, or local environmental sensors.

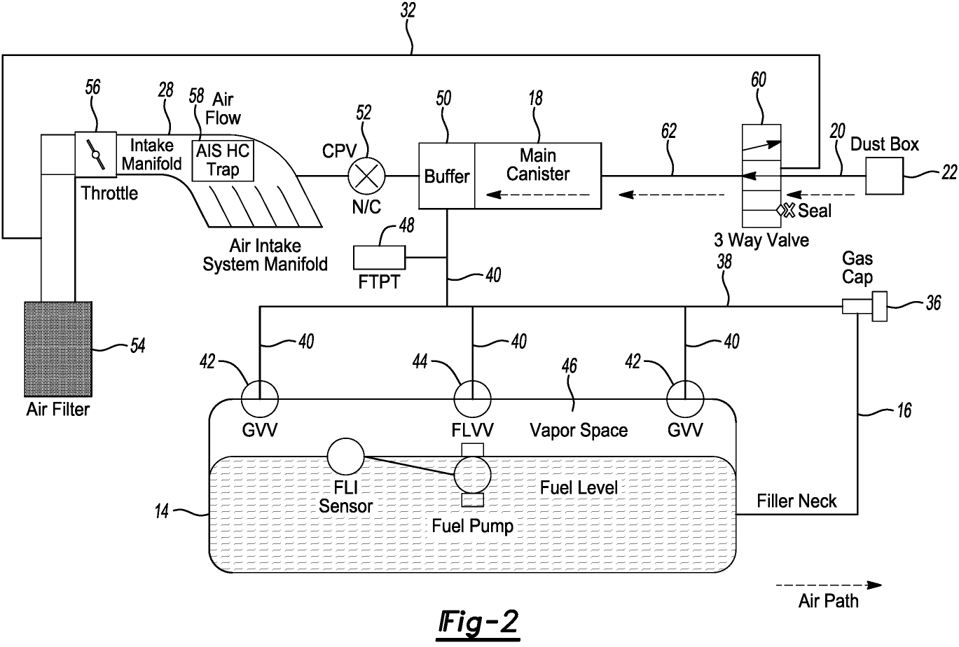

Referring to FIG. 2, the fuel system 12 is shown to include a fuel filler conduit 16, or filler neck, that is accessed for refueling by removing a gas cap 36. The fuel filler conduit 16 delivers fuel to the fuel tank 14 a fuel vapor recovery conduit 38 recovers fuel vapor released when refueling and includes several branches 40 that transfer fuel vapor from the fuel tank 14. A pair of grade limiting valves 42 release fuel vapor to the branches of the fuel vapor recovery conduit 38. A fuel limit valve 44 releases fuel vapor to one of the branches of the fuel vapor recovery conduit 38 from a vapor space 46 above the fuel in the fuel tank 14.

A fuel tank pressure transducer 48 monitors the pressure in the fuel tank and in the fuel vapor recovery conduit 38. The fuel vapor recovery conduit 38 releases fuel vapor to a buffer 50 of the fuel vapor storage cannister 18. Fuel vapor is stored in an adsorbent material in the fuel vapor storage cannister 18, for example, the adsorbent material may be activated carbon.

In a normal mode illustrated in FIG. 2, fuel vapor recovery is initiated when the controller 34 (shown in FIG. 1) opens the cannister purge valve 52 when the vehicle 10 is in operation and the engine 30 is operating. Vacuum from the intake manifold 28 draws fuel vapor from the fuel vapor storage container 18 through the buffer 50 and into the engine 30 to be combusted. Air is drawn into the engine 30 through an air filter, through the throttle 56, and by an air intake hydrocarbon trap 58.

A cannister vent valve 60 in the normal mode draws air through the dust box 22 and a first air purge line 20 and to the fuel vapor storage container 18 as the stored fuel vapor is ported to the intake manifold 28. The cannister vent valve 60 is a three-way valve controlled by the controller 34.

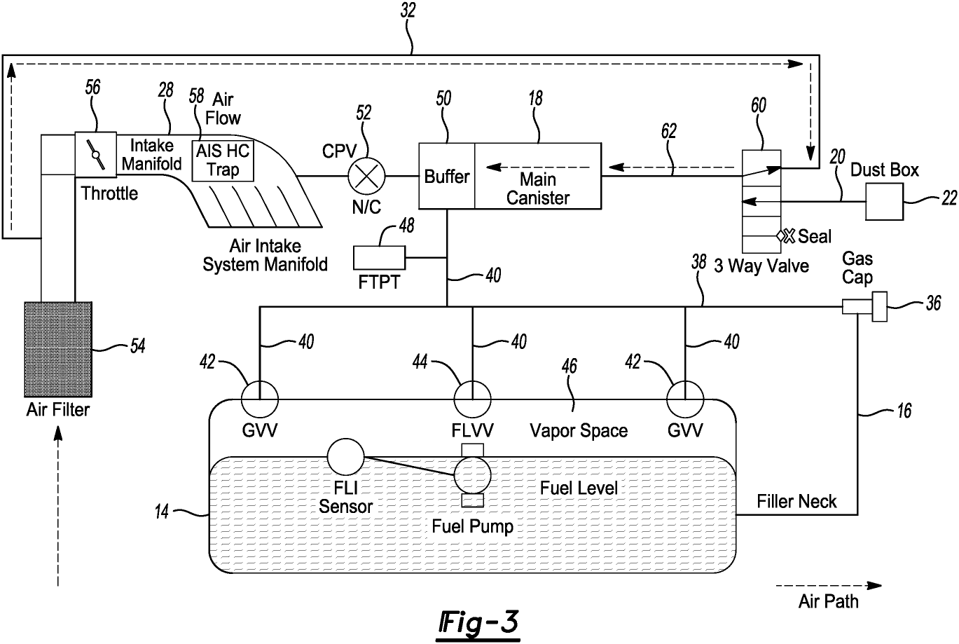

Referring to FIG. 3, a dusty condition mode of operation is illustrated wherein the cannister vent valve 60 in draws air through the air intake after flowing through the air filter 54 through the second air purge line 32. The cannister vent valve 60 is switched to the uppermost port illustrated in FIG. 3 by the controller and to the fuel vapor storage container 18 as the stored fuel vapor is ported to the intake manifold 28.

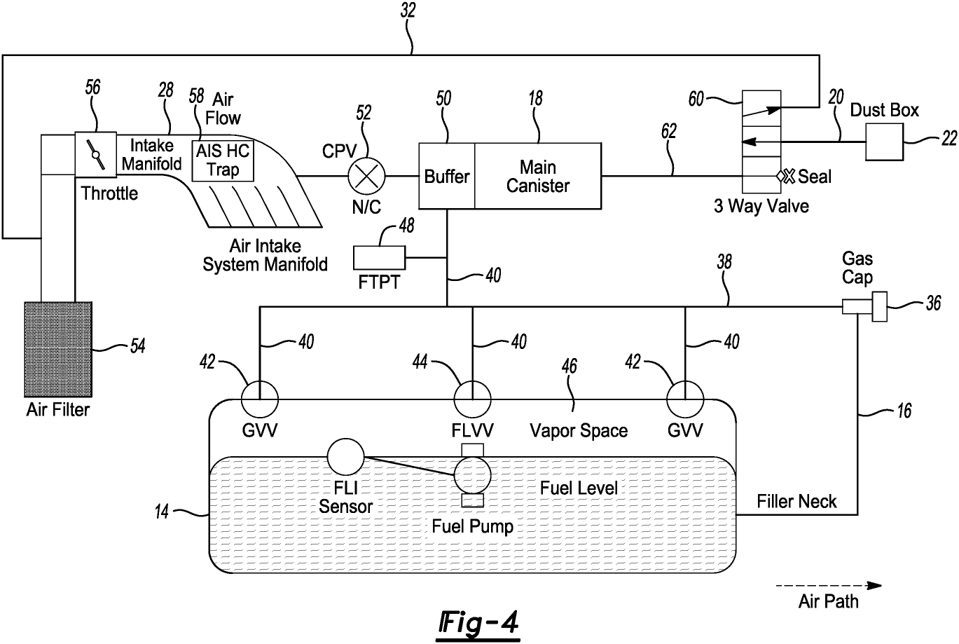

Referring to FIG. 4, a test condition mode is illustrated wherein the cannister vent valve 60 is closed by the controller 34 and is switched to a seal position for leak detection of the fuel system 12.

In dusty conditions when the volume or density of dust, or sensed extent of dust, in the environment of the vehicle 10 is greater than the predetermined level, the controller receives data indicating the level of dust in the environment of the vehicle 10 from onboard sources or from an external source. Examples of onboard sources include a laser sensor, an infrared sensor, an optical sensor, a camera, or the like. The onboard sources may be located at the front, rear or any convenient location on the vehicle.

A modem may be included as part of the controller 34 or may be a separate module. The modem may receive data from an external source, for example, a GPS system map indicating an unpaved road or off-road location, from reported weather conditions, or local environmental sensors.

A controller 34 is provided that receives the data indicating the level of dust in the environment of the vehicle 10 from onboard sources such as the front dust sensor 24, rear dust sensor 26, a dust sensor in a different location. Alternatively, a modem that may be part of the controller 34 may be used to receive data from an external source, such as a GPS system map indicating an unpaved road or off-road location, or from reports of weather conditions that may be received from a broadcast, the Internet, or local environmental sensors.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and includes modifications of the illustrated embodiments. In addition, the features of various implementing embodiments may be combined to form further embodiments of the invention.

What is claimed is:

1. A method of reducing dust ingestion into a fuel evaporation system, comprising:
providing a source of data indicating a quantity of dust in an environment of a vehicle;
controlling a source of purge air supplied to a vapor storage canister of an evaporative emission system based upon a quantity of dust particles in the environment of a vehicle;
providing purge air from a first source of purge air through a dust box to the vapor storage cannister when the quantity of dust particles is determined by a controller to be below a predetermined threshold; and
providing purge air from a second source of purge air from an engine intake system to the vapor storage cannister when the quantity of dust particles is determined by the controller to be above the predetermined threshold.

2. The method of claim 1 wherein the quantity of dust particles is measured by an on-board sensor.

3. The method of claim 1 wherein the quantity of dust particles is measured by a camera.

4. The method of claim 1 wherein the quantity of dust particles is measured by a sensor selected from the group consisting of:
a laser;
an infrared sensor; and
an optical sensor.

5. The method of claim 1 wherein the quantity of dust particles is data obtained from a global positioning map indicating that the vehicle is not being operated on a paved road.

6. The method of claim 1 wherein the quantity of dust particles is data obtained from a source external to the vehicle that provides data via a modem on the vehicle relating to the quantity of dust in the environment of the vehicle.

7. The method of claim 1 wherein the step of controlling the source of purge air is performed by the controller that switches a valve to provide purge air from the first source or the second source.

8. The method of claim 7 wherein the valve is a three-way valve with a first port that is opened to provide purge air from the first source, a second port that is opened to provide purge air from the second source, and a third port that prevents purge air from being provided to the vapor storage canister in a leak test mode.

9. A system for reducing dust ingestion into a fuel evaporation system, comprising:
a fuel tank;
a filler neck for supplying fuel to the fuel tank;
a vapor storage canister of an evaporative emission system;
a source of data that indicates a quantity of dust particles in the environment of a vehicle;
a controller responsive to the data indicating the quantity of dust; and
a valve responsive to the controller that provides purge air from a first source of purge air through a dust box to the vapor storage canister when the quantity of dust particles is determined by the controller to be below a predetermined threshold, and providing purge air from a second source of purge air from an engine intake system to the vapor storage canister when the quantity of dust particles is determined by the controller to be above the predetermined threshold.

10. The system of claim 9 wherein the source of data is an on-board sensor.

11. The system of claim 9 wherein the source of data is a camera.

12. The system of claim 9 wherein the source of data is one selected from the group consisting of:
a laser;
an infrared sensor; and
an optical sensor.

13. The system of claim 9 wherein the source of data is data from a global positioning map indicating that the vehicle is not being operated on a paved road.

14. The system of claim 9 wherein the source of data is data from a source external to the vehicle that provides data via a modem on the vehicle relating to the extent of dust in the environment of the vehicle.

15. The system of claim 9 wherein the controller selects the source of purge air by switching a valve to provide purge air from the first source or the second source.

16. The system of claim 15 wherein the valve is a three-way valve with a first port that is opened to provide purge air from the first source, a second port that is opened to provide purge air from the second source, and a third port that prevents purge air from being provided to the vapor storage canister in a leak test mode.

17. A system for reducing dust ingestion into a fuel evaporation system, comprising:
a fuel tank having at least one grade limit venting valve, and a fuel limit venting valve;
a fuel filler conduit that the grade limit venting valve and the fuel limit venting valve open into;
a filler neck for supplying fuel to the fuel tank;
a fuel tank pressure sensor that monitors a pressure in the fuel filler conduit;
a vapor storage canister of an evaporative emission system that includes a buffer, wherein the fuel filler conduit transfers fuel vapor through the buffer to a vapor storage conduit, and wherein the vapor storage conduit encloses a fuel vapor storage medium that collects stored fuel vapor until the canister is purged;
an air vent that supplies purge air to the vapor storage canister through a first air supply conduit, wherein purge air is selectively drawn into the air vent through a dust box;
an intake manifold adapted to supply air to a vehicle engine, wherein purge air is selectively drawn into the vapor storage canister through a second air supply conduit through an intake manifold air filter;
a valve provided in the first air supply conduit and the second air supply conduit;
a source of data indicating a quantity of dust particles in an environment where a vehicle is operated; and
a controller operative when the canister is purged by passing the stored fuel vapor into the intake manifold when the engine is operating, the controller being responsive to the data indicating the quantity of dust, wherein the valve is controlled to provide purge air from the first air supply conduit through the dust box to the vapor storage canister when the quantity of dust particles is determined by the controller to be below a predetermined threshold, and to provide purge air from the second air supply conduit from the intake manifold to the vapor storage canister when the quantity of dust particles is determined by the controller to be above the predetermined threshold.

18. The system of claim 17 wherein the valve is a three-way valve with a first port that is opened to provide purge air from the first air supply conduit, a second port that is opened to provide purge air from the second air supply conduit, and a third port that prevents purge air from being provided to the vapor storage canister in a leak test mode.

19. The system of claim 17 wherein the source of data is an on-board sensor.

20. The system of claim 17 wherein the source of data is data from a source external to the vehicle that provides data via a modem on the vehicle relating to the extent of dust in the environment of the vehicle.
